(19) United States
(12) Patent Application Publication
(10) Pub. No.: US 2024/0249350 A1
(43) Pub. Date: Jul. 25, 2024

(54) GRAPHICAL USER INTERFACE FOR ANALYTICAL INSIGHT

(71) Applicant: Truist Bank, Charlotte, NC (US)

(72) Inventors: Randy Eric Borth, Concord, NC (US); Candice Mercer Roberts, Harrisburg, NC (US); WeiJen Lu, Raleigh, NC (US); Kelly Mosby Griffin, Matthews, NC (US); Adam Richard Rogers, Atlanta, GA (US)

(73) Assignee: Truist Bank, Charlotte, NC (US)

(21) Appl. No.: 18/157,373

(22) Filed: Jan. 20, 2023

(51) Int. Cl. G06Q 40/02

(52) U.S. Cl. CPC G06Q 40/02

(57) ABSTRACT

A financial dashboard in a digital banking system includes an account overview section and an overall financial health section. The account overview section displays data for a single customer account, and comprises a recent activity view and an upcoming activity view, each containing a transaction list and top spending categories, along with a cash flow summary for the current month and an activity chart for recent months. The upcoming activity is derived from sources of known upcoming transactions, such as mortgage payments, subscription fees, paychecks, etc. The overall financial health section displays data for all accounts belonging to the customer, including balance values for recent months, total and categorized spending across all accounts for the current month, a credit score, and other insights. Each display element of the account overview and overall financial health sections is constructed as a widget which the customer may reposition on the display as desired.

### FIELD

The present disclosure relates generally to the field of digital banking systems, and more particularly to a graphical user interface in a digital banking system which arranges graphical depictions and data in a manner designed to promote a user's insights into important trends, where the graphical depictions and data include transactional and spending data which have been summarized, analyzed and or projected using prescribed techniques.

### BACKGROUND

Digital banking systems are well known and used by many bank businesses and their customers. Two common types of digital banking systems are online web-based systems which interact with a user via a web browser window on a computer, and mobile applications (“apps”) which run on mobile devices such as smart phones and tablets. Both online web-based banking systems and mobile banking apps communicate with back-end servers which validate and execute specific transactions, provide data for display, etc. Both web-based and mobile app-based systems also include security and customer authentication features, where user-provided information and/or biometric information is collected from the customer and validated with data stored on the back-end server. Digital banking systems, including web-based and mobile app-based systems, are often referred to as online banking systems, which terms will be used interchangeably throughout the present disclosure.

Each customer has one or more accounts with the bank, which the customer may access and manage using the digital banking system. The accounts might include checking and/or savings accounts, credit cards, and possibly investment accounts or others. Customers typically receive periodic statements for each account—such as a monthly credit card statement—in which every transaction is listed (deposits, withdrawals, purchases, payments, etc.) and a new account balance is shown. These statements may be in paper or electronic form.

Customers who use a bank's digital banking systems also have access to near-real-time account information, where transactions are posted to the account ledger soon after the transaction's occurrence. For example, a credit card purchase at a coffee shop will often appear in the online transaction list for the credit card account within minutes of the purchase. This allows savvy online banking customers to regularly review their transaction list (e.g., to spot potential fraud) and also to keep track of their current account balance. These online transaction lists directly access data from a transaction database, and may be updated many times each day. By contrast, the account statements (described above) are produced only at the close of a statement period—such as monthly.

Digital banking systems are also known to provide other data for customer accounts besides the aforementioned transaction lists. For example, digital banking systems may provide a summary of spending or account balance for recent months, and the systems also typically offer convenience to the customer by way of links to features which customers often use—such as money transfers and bill paying.

Although existing digital banking systems provide many useful features and functions for bank customers, there is a need for an online banking system which improves customers' insights into their financial situation by providing analyses and displays which incorporate both recent and upcoming transactions, and by aggregating data across multiple accounts.

### BRIEF SUMMARY

The present disclosure describes a method and system for providing a financial dashboard in a digital banking system. The dashboard includes an account overview section and an overall financial health section. The account overview section displays data for a single customer account, and comprises a recent activity view and an upcoming activity view, where each of the views contains a transaction list and top spending categories, along with a cash flow summary for the current month and an activity chart for recent months. The upcoming activity is derived from sources of known upcoming transactions, such as mortgage or loan payments, subscription fees, paychecks, etc. The overall financial health section displays data for all accounts belonging to the customer user of the digital banking system, including balance values for recent months, total and categorized spending across all accounts for the current month, a credit score, and other insights. Each display element of the account overview section and the overall financial health section is constructed as a widget which the customer may reposition on the display as desired.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

FIG. 1 illustrates an enterprise system, and environment thereof, including a centralized server system, distributed computers and mobile devices, and communication therebetween, according to at least one embodiment of the present disclosure;

FIG. 2 is a simplified illustration of the enterprise system of FIG. 1, showing the elements most directly involved in the graphical user interface for analytical insight embodied in the present disclosure;

FIG. 3 is a mock-up illustration of a display screen of a computing device running a digital banking application, depicting an account overview including various data displays and insights related to recent activity for a particular account of a user, according to an embodiment of the present disclosure;

FIG. 4 is a mock-up illustration of the display screen of the computing device running the digital banking application, depicting an account overview including various data displays and insights related to recent and upcoming activity for the particular account, according to an embodiment of the present disclosure;

FIG. 5 is a mock-up illustration of the digital banking application on the display screen, depicting a complete user dashboard including the account overview of FIG. 3 along with a financial health section containing various data displays and insights for all accounts of the user of the digital banking application, according to an embodiment of the present disclosure; and

FIG. 6 is a flowchart diagram of a method for computing and displaying financial account data in a digital banking application, according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

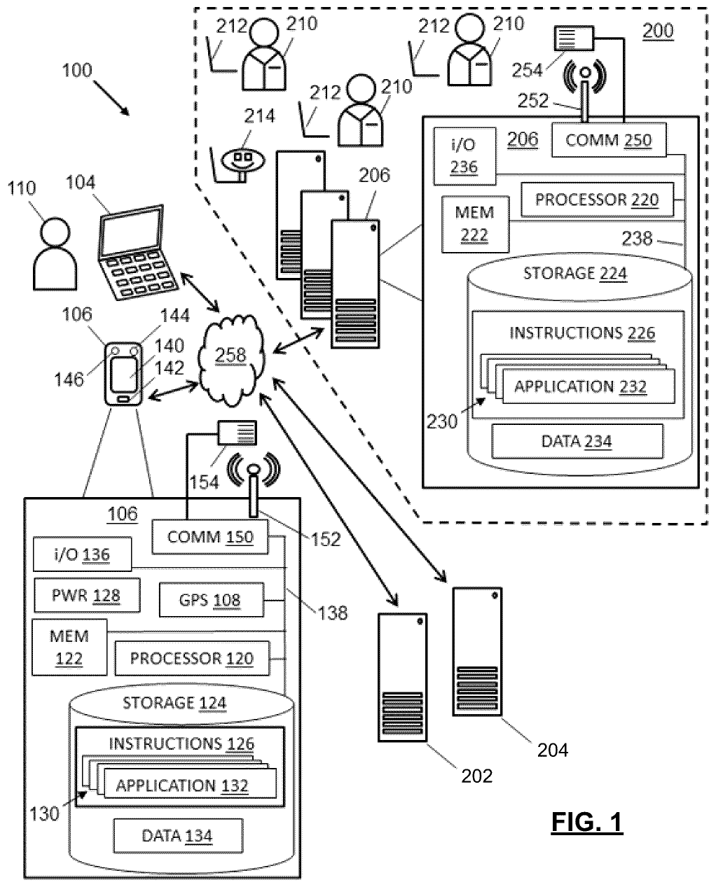

FIG. 1 illustrates a system 100 and environment thereof, including centralized and distributed computing devices, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11 a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

Having described an enterprise computing environment as might be used by a banking business, and general characteristics of systems which may be employed in the enterprise computing environment, attention is now turned to the topic of a graphical user interface designed to promote a user's insights into important trends in individual accounts and across multiple accounts in connection with the digital banking system.

Digital banking systems are well known and used by many bank businesses and their customers, including online web-based systems which interact with a user via a web browser window, and mobile applications (“apps”) which run on mobile devices such as tablets and smart phones. Both online web-based banking systems and mobile banking apps communicate with back-end servers which validate and execute specific transactions, provide data for display, etc.

Banking customers have at least one account, and often more than one account, with a bank business. These accounts may include savings accounts, checking accounts, investment accounts, credit cards, loans, mortgages, etc. Customers receive a statement for each account, typically once per month. The statement lists a beginning balance, all transactions for the statement period, and an ending balance, among other things. Online banking systems also typically provide customers with access to near-real-time transaction lists for each account, where transactions appear in the online system as soon as they are posted to the bank's back end database.

In addition, databases are available from third party sources which contain supplemental data related to the transactions in the bank customers' online transaction lists. Other data is also available from third party sources which is either related to activity in a specific customer account or is related to other accounts of the customer, or an overall financial status of the customer. This supplemental data can be integrated with the bank's own transaction data in ways which allow the customer to gain a better understanding of his or her financial situation than any of the individual data sources alone would provide.

Techniques for integrating data from one or more third-party data sources with the bank's own data—including adding new data fields to transaction data records, and selecting data fields from a third-party source to overwrite a common data field of the bank's own data—were disclosed in U.S. patent application Ser. No. 18/154,291, Titled “DATA SOURCE INTEGRATION”, filed on Jan. 13, 2023 and commonly assigned with the present application. The application Ser. No. 18/154,291 is hereby incorporated by reference in its entirety, and will hereinafter be referred to as “the '291 application”.

The techniques of the present disclosure describe methods for displaying digital banking system data in a dashboard system which provides financial insights to the customers. This is done by analyzing available data and displaying trends in ways which promote the insights. These analysis and display techniques are discussed below with respect to the remaining figures.

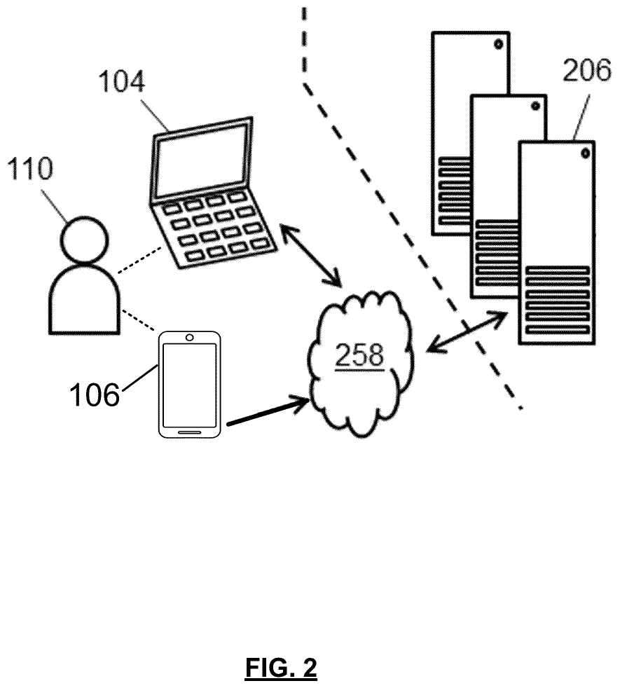

FIG. 2 is a simplified illustration of the enterprise architecture depicted in FIG. 1, showing the elements most directly involved in the graphical user interface for analytical insight embodied in the present disclosure. The user 110 uses either the computing device 104 or the mobile device 106 to access a digital banking system, where the computing device 104 would run a web browser application in which the digital banking system is displayed, and the mobile device 106 would run a mobile app specifically designed as the digital banking system. The computing device 104 and/or the mobile device 106 communicate with the computing system (back-end servers) 206 via the network (“cloud”) 258.

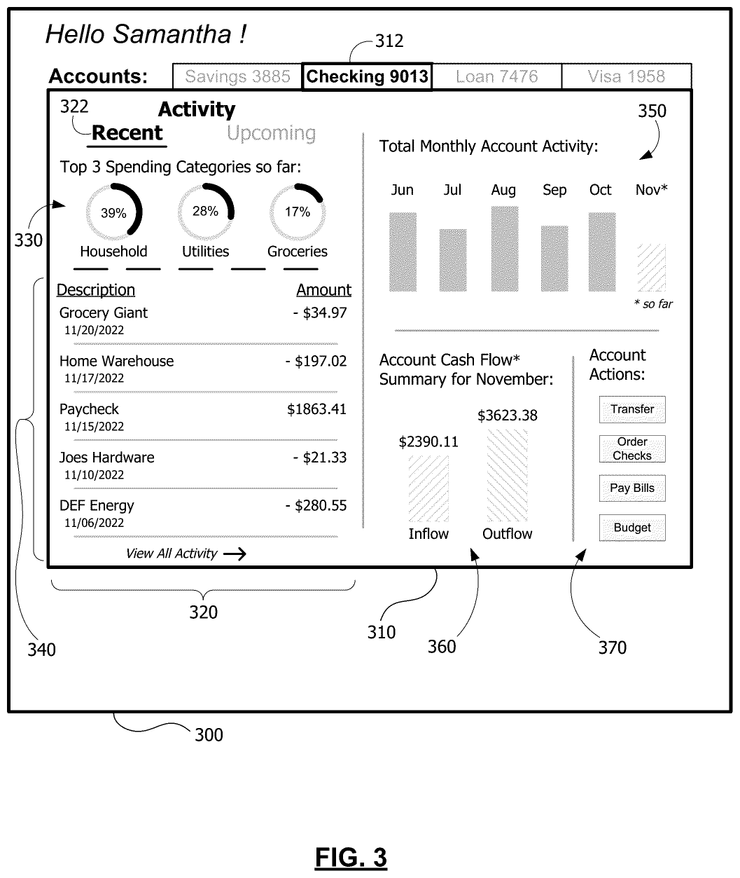

FIG. 3 is a mock-up illustration of a display screen 300 of a computing device running a digital banking application, depicting an account overview including various data displays and insights related to recent activity for a particular account of a user, according to an embodiment of the present disclosure.

The display screen 300 of FIG. 3 is depicted in a manner which generally corresponds with a computer monitor, where the computer is running a web browser application and the monitor has a large display area. That is, a lot of information can be displayed simultaneously, as shown in FIG. 3 (and later figures). It is to be understood that in other embodiments of the present disclosure, a mobile app is configured to display the same information depicted in FIG. 3; however, because of the smaller screen area of mobile devices (especially smart phones), the data displays may be distributed across multiple pages of the app, where the user navigates the pages using tabs at the top and/or bottom of the screen, or other suitable techniques.

The display screen 300 of FIG. 3 (depicted as a computer monitor, as discussed above) is part of, or communicates with, a computer which corresponds with the computing device 104 of FIGS. 1 and 2. It is to be understood that the computer and display screen 300 of FIG. 3 communicate with a back-end server such as the computing system 206 of FIGS. 1 and 2, by way of communications channels such as WiFi and/or cellular communication networks as illustrated by the network 258 (“the cloud”). In other embodiments, the display screen 300 is the display of the mobile device 106, where the mobile app may format the data differently than shown in FIG. 3 but the same displays and insights are available.

An account overview section 310 includes several data displays and insights in connection with a particular account of the user. If the user has more than one account with the bank, as is often the case, any one of the accounts may be selected using the tabs at the top of the account overview section 310. In FIG. 3, the particular account selected is a checking account ending in the digits 9013, as indicated at 312. Other accounts (not selected)—including a savings account, a loan account and a credit card account—are also shown. The checking account is used as an example in the figures because checking accounts, with associated debit cards, typically see a lot of transactional activity.

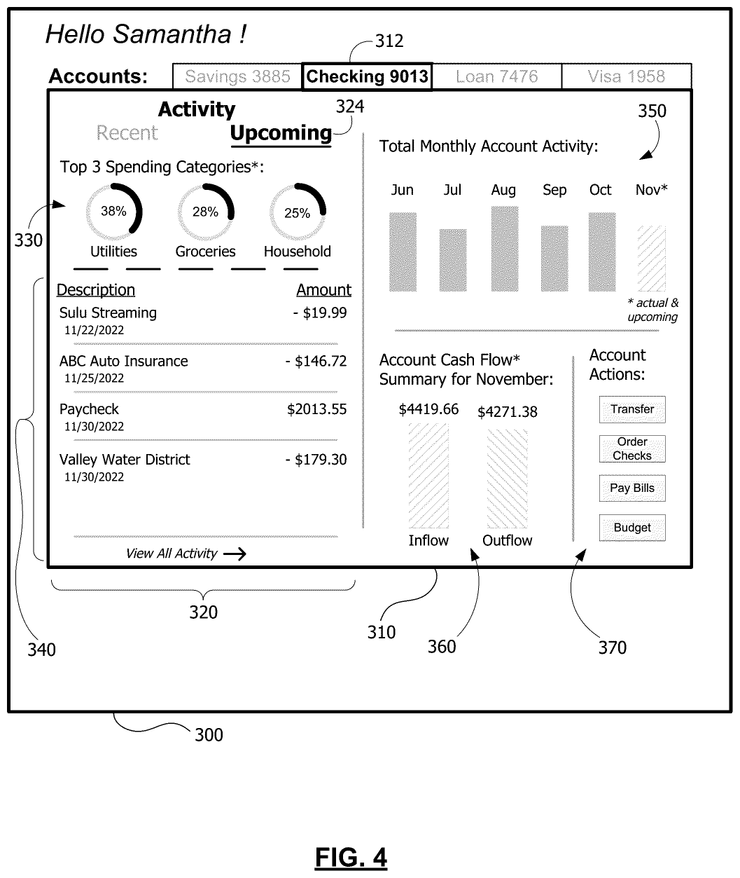

On the left side of the account overview section 310 is a transaction section 320. The transaction section 320 allows the user to select a recent transactions view or an upcoming transactions view. In FIG. 3, the recent transactions view is selected as indicated at 322. The upcoming transactions view is discussed with respect to FIG. 4.

Near the top of the transaction section 320 is a graphical indicator of the top three spending categories for the account, indicated at arrow 330. Assigning a category (e.g., groceries, entertainment, etc.) to purchase transactions is a common practice, and techniques for allowing the user to reassign the category for individual transactions were discussed in the '291 application. Understanding spending trends by category can therefore be a very useful budgeting and planning tool for consumers.

In one embodiment, the top three spending categories are shown for the current month to date (“so far”), which could be either based on a calendar month or a statement billing cycle month (or user selectable as one or the other). The top three spending categories depicted at 330 are shown as circle graphs where the percentage of spending for transactions in the particular category is displayed as an arc covering a proportional circumference of the circle. In other words, for a category that has a 25% share of the spending, the arc would circumscribe one-quarter of the circle, or 90°. Other types of graphs may also be used to convey the same spending-by-category information to the user. Regardless of the specific graphical format, the display of spending trends by category provides a quick and helpful financial insight to the customer.

Directly below the top spending categories at 330, a transaction list 340 is provided. The transaction list 340 displays a list of transactions (recent transactions in this case), including a description (usually a merchant name for purchases), a transaction date and a transaction amount for each transaction. The transactions are typically listed in chronological order, with the most recent at the top of the list. A link to view all transaction activity is provided at the bottom of the transaction list 340, where the full transaction list would typically be a scrollable list of all transactions in the current billing period (or another selected period), and could contain additional data (such as category) for each transaction.

In the upper right of the account overview section 310 is a monthly total section 350. The monthly total section 350 includes a bar chart showing total spending, in the selected account, for the past several months. In one embodiment, the current month spending so far is shown in a bar which has a different color or fill pattern. The monthly total section 350 provides a financial insight to the consumer by way of comparison of spending trends over time.

Below the monthly total section 350 is an account cash flow section 360. In one embodiment, the account cash flow section 360 depicts the cash inflow and outflow for the selected account, for the current month so far, as side-by-side bars with numerical values attached. Other graphical formats may be used as suitable. The account cash flow section 360 provides another important financial insight to the consumer, indicating which direction the account is trending.

To the right of the account cash flow section 360 is an account actions section 370. The account actions section 370 includes buttons or links which the user may click in order to take certain actions—such as transferring funds, ordering checks, paying bills, etc. Other or different actions may be included in the account actions section 370, as would be understood by those familiar with digital banking systems.

The positioning and size/shape of the various sections and displays within the account overview section 310 may of course be changed without departing from the spirit of the present disclosure. Also, as discussed above, the various sections and displays may appear very differently than shown in FIG. 3 on a mobile device such as a smart phone with a small display area. For example, in a mobile app on a smart phone, the transaction section 320 may occupy the entire display screen—and tabs, up and down scrolling and/or left and right swipes may be used to access other sections and data displays.

FIG. 4 is a mock-up illustration of the display screen 300 of the computing device running the digital banking application, as in FIG. 3, except in this case depicting an account overview including various data displays and insights related to recent and upcoming activity for the particular account, according to an embodiment of the present disclosure. The account overview section 310 in FIG. 4 is laid out identically to the account overview section 310 of FIG. 3; however, in FIG. 4, the account activity for upcoming activity is selected (at 324), rather than for recent activity as in FIG. 3. In one embodiment, the inclusion of upcoming activity causes data values to be changed in most of the sections of the account overview section 310.

Upcoming activity for an account may be determined from a variety of data sources. For example, some consumers subscribe to financial planning services which track many forms of budgetable activity—such as paychecks, recurrent subscription fees, insurance premiums, mortgage and loan payments, etc. The upcoming activity may be obtained from such a financial planning service. In addition, the date and amount of many types of credits and debits can be learned from their individual sources—such as employers for paycheck deposits, and mortgage lenders, insurance companies, subscription services, public utilities, and issuers of credit cards and loans for their respective types of payments. Because so many types of income and spending activity are known in advance, they can advantageously be incorporated into the account transaction data. The resulting upcoming view of the account overview section 310 provides an extremely valuable financial insight and planning tool to the consumer.

In the transaction section 320, the top three spending categories for the account, at 330, have been updated to reflect both actual and upcoming spending, as indicated by the asterisk. It can be seen that the top three categories are still utilities, groceries and household, but their relative order has changed as a result of their revised percentages of spending, where the percentages now include both actual and upcoming transactions.

The transaction list 340 now includes only upcoming transactions, in chronological order with the soonest upcoming transaction listed first, followed by later upcoming transactions. The inclusion of upcoming transactions in the transaction list 340 provides the user with extremely valuable spending insight, for several reasons. First, it is easy for a person to forget about upcoming payments which are made on a less frequent basis, such as quarterly or annually; these payments are shown in the transaction list 340 so that the user is aware of them. Second, it is very convenient to see the upcoming transactions involving many different parties in a single list, as opposed to having to track down the data from each individual source. Third, having an accounting of all known upcoming transactions in the user's account overview allows the user to determine in advance what impact these upcoming transactions will have on cash flow and account balance.

In the monthly total section 350, the activity total for the current month may be revised to include both actual and upcoming spending, as indicated by the asterisk. The same is true for the account cash flow section 360, where both the inflow and outflow amounts are revised to include both actual and upcoming activity. If a particular user does not wish to see the upcoming activity incorporated into the bar charts of the monthly total section 350 and the account cash flow section 360, this preference could be accommodated with a user configuration setting in the digital banking system.

The account actions section 370 is unchanged in the upcoming activity view (FIG. 4) relative to the recent activity view (FIG. 3).

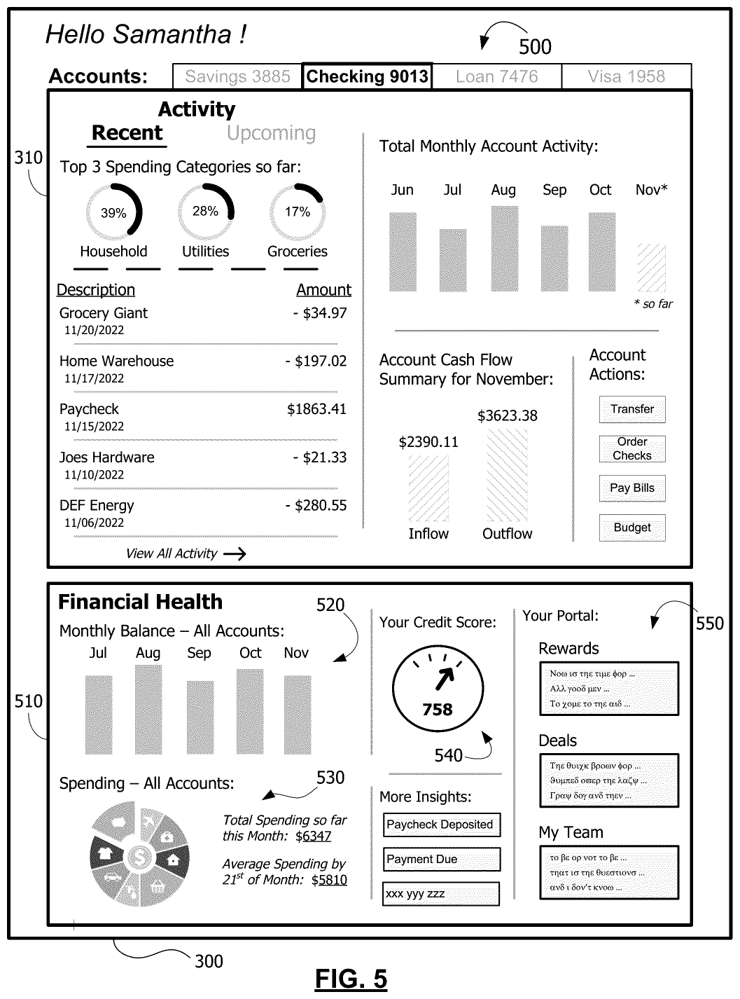

FIG. 5 is a mock-up illustration of the digital banking application on the display screen, depicting a complete user dashboard 500 including the account overview of FIG. 3 along with a financial health section containing various data displays and insights for all accounts of the user of the digital banking application, according to an embodiment of the present disclosure. FIG. 5, like the earlier figures, illustrates a large-format display screen such as a computer monitor, where a lot of information can be displayed at once. Once again, all of the information, data displays, graphics and insights depicted in the computer screen format of FIG. 5 are also available in mobile app form (such as on a smart phone).

The dashboard 500 includes the account overview section 310 which provides financial insights in connection with a single account of the user, as discussed in detail above with respect to FIGS. 3 and 4. The dashboard 500 also includes a financial health section 510 which provides insights into the overall financial picture for the user—including data which is aggregated across multiple accounts, and other information.

The financial health section 510 includes a bar chart depicting the monthly balance for all user accounts over the past several months, as indicated at 520. The monthly balance chart provides the user with a clear and concise understanding of their aggregate account balance over time, which enables insight into any positive or negative trend. By aggregating the balance across all accounts (e.g., savings, checking, investment, etc.), the monthly balance chart eliminates the hassle or guesswork of looking up multiple account balances individually and adding them up. In addition, the monthly balance chart may include data for accounts held at a different financial institution, if the user chooses to make such data available to the digital banking system. The monthly balance data may take some other form besides the bar charts shown in FIG. 5. The monthly balance data may also be shown for credit card accounts, where the credit card balances (liabilities) are shown either separately from or superimposed upon the savings and checking account balances (assets).

Directly below the monthly balance chart is a spending by category chart, as indicated at 530. Like the monthly balance chart discussed above, the spending by category chart reflects all user accounts—including accounts held at different financial institutions if applicable. The spending by category chart may be computed for spending in the current month (calendar or statement), or for a longer period of time (e.g., past six months) selected by the user.

In some embodiments, the spending chart is displayed as a wheel chart or pie chart, with each category occupying a segment of the circle proportional to its percentage of overall spending. Each category (travel, groceries, household, etc.) may preferably be labeled with a simple graphical icon (e.g., an airplane for the travel category). Additional details may be obtained by the user hovering over or clicking on a segment of the spending chart. This could result in a pop-up bubble which lists the category, the total spending in that category, and even a list of transactions included in the category spending.

The spending by category chart derives its data from all applicable user accounts—which could include multiple checking accounts (with debit cards) and multiple credit card accounts. Collecting data from all of these accounts and analyzing it by category of spending provides a tremendous insight for the consumer, whether looking for areas to reduce spending, or simply interested in gaining a better understanding of spending patterns for budgeting purposes.

The financial health section 510 also includes a credit score display 540, depicted here as a meter or gauge with the needle pointing at a position on the gauge corresponding to the user's numerical credit score, which is also displayed inside or near the gauge. The credit score may be obtained from one or more of the credit bureaus, where the displayed credit score is an average when more than one independent credit bureau score is available. Providing the credit score display 540 in the financial health section 510 is a convenience to the user, as the intention of the dashboard 500 is to portray a complete picture of the consumer's financial status, with the ability to dig deeper as desired. Furthermore, the user may gain insight into the change in credit score over time as it correlates with other data on the dashboard 500—such as account balances.

A section 550 is labeled “Your Portal”, and contains buttons or links to other information, features and functions that the user may find convenient. These include things like rewards earned by the user (e.g., credit card points or cash back), deals available to the user (discounts received as a result of various accounts and activities of the user), and a list of contacts which the user may call on for certain information or services. Other buttons and links may be provided in the section 550, either in place of or in addition to those shown in FIG. 5.

Below the credit score display 540 is a section titled “More Insights”, which includes buttons or links which allow the user to quickly get more information about certain events—such as a paycheck recently deposited, or an upcoming payment due (such as for an auto loan or a credit card). The insights are designed as “teasers” containing few words which the user can parse very quickly, understand the context, and pursue further if interested. Many other such insights may be listed, either in place of or in addition to those shown, and it is envisioned that these insights change automatically based on current events.

In some embodiments, each of the display sections in the dashboard 500 discussed above (e.g., the transaction section 320, the monthly total section 350, the credit score display 540, etc.) is constructed as a “widget”, which can be configured according to each user's preferences—that is, included or not included, and resized and/or repositioned on the dashboard 500.

Furthermore, like the “More Insights” discussed above, most or all of the graphs and charts depicted in FIG. 5 may be configured as teasers, where the user can hover over or click on an item (such as one of the transactions in the transaction list, or one element of a bar graph or chart) to see additional details. In some cases, the additional details are provided in a temporary pop-up bubble, and in other cases clicking to get additional details takes the user to a different web page or app page, preferably with a link to conveniently return to the previous page.

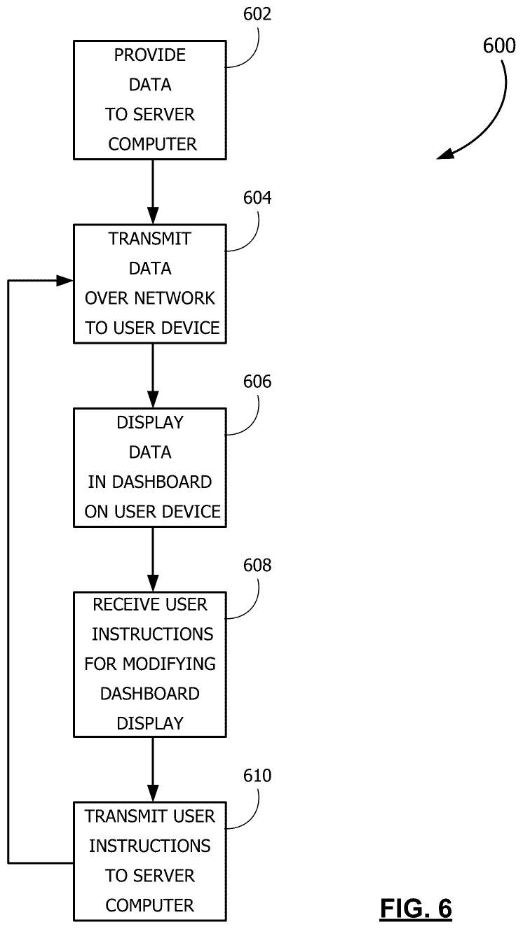

FIG. 6 is a flowchart diagram 600 of a method for computing and displaying financial account data in a digital banking application, according to an embodiment of the present disclosure. At box 602, data is provided to a server computer, which is in communication with a plurality of user devices. The data is financial data for each of a bank's customers, including one or more account for each customer. Methods for aggregating and refining the financial data, including integration of data from multiple sources, were disclosed in the '291 application.

At box 604, data for an individual customer is transmitted over a network to the customer's user device. The user device may be a personal computing device running a web browser application (in which the bank's digital banking system is running), or the user device may be a mobile device such as a smart phone or a tablet running the digital banking systems as a mobile app. At box 606, the data for the customer is displayed as a financial dashboard on the user device, as depicted in FIG. 5 and discussed above. The financial dashboard includes the account overview section and the overall financial health section, with the various features, graphics, data and configurable views discussed above.

At box 608, the user provides instructions for interaction with the financial dashboard, such as by clicking on a graph or a transaction to get additional details, or selecting the upcoming activity view of the overview section. The user instructions are received by the user device at the box 608, and transmitted over the network to the server computer at box 610. The process then loops back to the box 604 where the data indicated by the user instructions is transmitted from the server computer to the user device for updating the display of the financial dashboard.

The user may also reposition and/or resize individual elements of the financial dashboard, where each element is programmed as a “widget” for this purpose.

It is to be understood that the method of FIG. 6, and the user interface and graphical display features shown on FIGS. 3-5, are programmed as one or more algorithm which runs on the computing system 206 (the enterprise server) cooperatively and interoperably with the computing device 104 and/or the mobile device 106 of the customer. For example, the computing device 104 or the mobile device 106 receives input from the user in the form of mouse clicks and screen taps along with optional keyboard inputs, and provides the user inputs to the computing system 206 which delivers data (e.g., transaction lists, monthly balance values, etc.) back to the computing device 104 or the mobile device 106. These devices all include processors, memory and communication modules suitable to run the algorithm(s) and perform the digital banking dashboard display in the manner described throughout the present disclosure.

The preceding discussion has been structured in terms of a single customer and that customer's internal accounts (with the bank business itself) and external accounts (held at other financial institutions). It is to be understood that all of the bank's customers have access to the disclosed graphical user interface features in the online banking systems, and that all of the account data are correspondingly stored in relation to the appropriate customer, the specific account(s) of that customer, the specific transactions within that account, etc., in a manner which would be understood by those familiar with transactional database systems.

The graphical user interface for analytical insights in a digital banking system, discussed above, provides features which enable customers to quickly and thoroughly understand the details of individual accounts along with their overall financial situation. These features are provided in a dashboard which includes individual graphical display elements not found in existing online banking systems, and which collectively provide capabilities which result in increased customer satisfaction and ultimately a growing customer base.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A method for providing a graphical user interface for analytical insight, said method comprising:
providing, to a server computer having a processor and memory, a source of data to be displayed in the graphical user interface;
transmitting at least a portion of the data over a network from the server computer to a user device having a processor, memory and a display screen;
displaying the graphical user interface on the user device, where the graphical user interface includes a first section and a second section;
receiving user instructions for modifying what is displayed on the graphical user interface;
when indicated by the user instructions, transmitting the user instructions from the user device to the server computer and transmitting additional data from the server computer to the user device over the network; and
updating the display of the graphical user interface on the user device based on the user instructions.

2. The method according to claim 1 wherein the user device is a tablet device or a smart phone configured with a mobile application which communicates with the server computer.

3. The method according to claim 1 wherein the user device is a personal computing device configured with a web browser application which communicates with the server computer.

4. The method according to claim 1 wherein the data is financial data for one or more accounts of a user, and the graphical user interface is a financial dashboard where the first section is an account activity section and the second section is an overall financial health section.

5. The method according to claim 4 wherein the account activity section displays financial data for one account, and the one account is selectable by the user when the financial data for more than one account is provided.

6. The method according to claim 4 wherein the account activity section includes a top spending categories graphic depicting transaction categories having highest spending amounts in the one account for a current month, a transaction list for the one account, a total monthly activity chart depicting spending totals in the one account for a plurality of recent months including the current month, and a cash flow chart depicting inflow and outflow amounts for the one account in the current month.

7. The method according to claim 6 wherein the current month is selectable by the user to be either a calendar month or an account statement period month.

8. The method according to claim 6 wherein the account activity section is user-configurable to display either a recent activity view or an upcoming activity view.

9. The method according to claim 8 wherein, when the account activity section is displaying the upcoming activity view, the transaction list includes upcoming transactions, and the top spending categories graphic, the total monthly activity chart and the cash flow chart all include both actual and upcoming transactions for the current month.

10. The method according to claim 4 wherein the overall financial health section reflects all of the financial data of the user, and the overall financial health section includes a monthly balance chart depicting total balance in all of the one or more accounts for a plurality of recent months including a current month, a spending by category chart depicting spending category percentages for spending in all of the one or more accounts in the current month, and a user credit score value.

11. The method according to claim 4 wherein the user instructions include selecting an element from either the account activity section or the overall financial health section to get additional detail about the element, and repositioning and/or resizing an element on the financial dashboard.

12. A method for providing a financial dashboard, said method comprising:
providing, to a server computer having a processor and memory, a source of data to be displayed on the financial dashboard, where the data is financial data for one or more accounts of a user;
transmitting at least a portion of the data over a network from the server computer to a user device having a processor, memory and a display screen;
displaying the financial dashboard on the user device, where the financial dashboard includes an account activity section and an overall financial health section, and where the account activity section is user-configurable to display either a recent activity view or an upcoming activity view for one account of the user, and the account activity section includes a top spending categories graphic depicting transaction categories having highest spending amounts in the one account for a current month, a transaction list for the one account, a total monthly activity chart depicting spending totals in the one account for a plurality of recent months including the current month, and a cash flow chart depicting inflow and outflow amounts for the one account in the current month;
receiving user instructions for modifying what is displayed on the financial dashboard, where the user instructions include selecting an element from either the account activity section or the overall financial health section to get additional detail about the element;
when indicated by the user instructions, transmitting the user instructions from the user device to the server computer and transmitting additional data from the server computer to the user device over the network; and
updating the display of the financial dashboard on the user device based on the user instructions.

13. A system for displaying a financial dashboard, said system comprising:
a plurality of user devices; and
a server computer in communication with the user devices and having at least one processor and memory,
where the server computer is configured for;
reading a source of data to be displayed on the financial dashboard, where the data is financial data for one or more accounts of a user, and
transmitting at least a portion of the data over a network to a particular one of the user devices being used by the user;
and the user devices are configured for;
displaying the financial dashboard including an account activity section and an overall financial health section,
receiving user instructions for modifying what is displayed on the financial dashboard, and
when indicated by the user instructions, transmitting the user instructions to the server computer;
and the server computer is further configured for transmitting additional data to the user devices as required by the user instructions;
and the user devices are further configured for updating the display of the financial dashboard based on the user instructions.

14. The system according to claim 13 wherein the user devices include tablet devices and smart phones configured with a mobile application which communicates with the server computer, and personal computing devices configured with a web browser application which communicates with the server computer.

15. The system according to claim 13 wherein the account activity section displays financial data for one account, and the one account is selectable by the user when the financial data for more than one account is provided.

16. The system according to claim 15 wherein the account activity section includes a top spending categories graphic depicting transaction categories having highest spending amounts in the one account for a current month, a transaction list for the one account, a total monthly activity chart depicting spending totals in the one account for a plurality of recent months including the current month, and a cash flow chart depicting inflow and outflow amounts for the one account in the current month, and where the current month is selectable by the user to be either a calendar month or an account statement period month.

17. The system according to claim 16 wherein the account activity section is user-configurable to display either a recent activity view or an upcoming activity view.

18. The system according to claim 17 wherein, when the account activity section is displaying the upcoming activity view, the transaction list includes upcoming transactions, and the top spending categories graphic, the total monthly activity chart and the cash flow chart all include both actual and upcoming transactions for the current month.

19. The system according to claim 13 wherein the overall financial health section reflects all of the financial data of the user, and the overall financial health section includes a monthly balance chart depicting total balance in all of the one or more accounts for a plurality of recent months including a current month, a spending by category chart depicting spending category percentages for spending in all of the one or more accounts in the current month, and a user credit score value.

20. The system according to claim 13 wherein the user instructions include selecting an element from either the account activity section or the overall financial health section to get additional detail about the element, and repositioning and/or resizing an element on the financial dashboard.
